(19) United States
(12) Patent Application Publication
(10) Pub. No.: US 2025/0226529 A1
(43) Pub. Date: Jul. 10, 2025

(54) ZNP2 MODIFIED SEPARATOR TO IMPROVE THE ABSORPTION AND CONVERSION KINETIC OF POLYSULFIDES FOR METAL-SULPHUR BATTERIES

(71) Applicant: COUNCIL OF SCIENTIFIC AND INDUSTRIAL RESEARCH, New Delhi (IN)

(72) Inventors: Manjusha Vilas Shelke, Pune (IN); Poonam Yadav, Pune (IN); Anoushka Krishna Das, Pune (IN)

(21) Appl. No.: 18/853,072

(22) PCT Filed: Mar. 28, 2023
(86) PCT No.: PCT/IN2023/050297

§ 371 Date: Sep. 30, 2024

(30) Foreign Application Priority Data
Mar. 28, 2022 (IN) 202211018239

(51) Int. Cl. H01M 50/431; H01M 4/02; H01M 4/36; H01M 4/38; H01M 4/583; H01M 10/052; H01M 50/403; H01M 50/417; H01M 50/446; H01M 50/449; H01M 50/562

(52) U.S. Cl. CPC H01M 50/431; H01M 4/364; H01M 4/382; H01M 4/583; H01M 10/052; H01M 50/403; H01M 50/417; H01M 50/446; H01M 50/449; H01M 50/562; H01M 2004/027; H01M 2004/028

(57) ABSTRACT

A ZnP₂ coated separator as a barrier to restrict the polysulfide shuttling is provided. A ZnP₂ coated separator have surface anchoring group to bind and catalyze sulfide conversion is also provided. Further, a process is provided for synthesizing the ZnP₂ modified separator. Furthermore, an energy device with the coated separator is described.

### FIELD OF THE INVENTION

The present invention relates to lithium-sulfur rechargeable battery. More particularly, the present invention relates to the phosphide coated separator as a barrier to restrict the ion shuttling.

### BACKGROUND AND PRIOR ART OF THE INVENTION

Lithium-sulfur (Li—S) batteries are a particular type of rechargeable battery. Li—S batteries have gained research and industrial interest due to its high theoretical capacity and energy density for widespread adoption of electrification of transportation, energy density, cycle life and cost of energy storage systems such as batteries need to be improved. Current world's energy demand is supplied by non-renewable resources such as Coal, oil and gases. These resources will deplete in near future and energy demand will continuously rise to ˜1250 GW by 2030. Major source of energy supply will be battery storage by the end of this decade. Search for “Green energy” sources is another reason for creating an interest to electric energy storage.

Li-ion batteries (LIBs) are being widely used today due to their high energy density and higher operating potential. Generally, battery includes five main components cathode, anode, electrolyte, separator and current collectors. To reach the goal of widespread adoption of batteries in electronic power sources and transportation, limitations such as low energy density, less cycle life, less safety and high cost need to be addressed. It is very crucial to optimize each component of battery to reach the goal of higher energy density (500 Whkg⁻¹) and cycle life. Li metal batteries (LMBs) possess highest energy density and have potential to meet the energy requirements for the electric vehicles (EVs) on a commercial scale. This is attributed to highest electrochemical potential (−3.04V vs. SHE) and capacity (3860 mAhg⁻¹, 2061 mAh cm⁻³) of Li metal.

In cathode materials, Sulfur is an promising cathode candidate because of its higher theoretical capacity (1675 mA h g⁻¹) and a safe voltage range (1.5-2.8 V) accompanied with low cost.

Hence, Li anode is preferably combined with sulfur cathode (1675 mAhg⁻¹) in full cell to achieve the increased energy density, of the order of >600 Whkg⁻¹.

The commercial applicability of Li—S batteries is presently very limited because of their poor cycle stability. Therefore, before commercialization of sulfur cathode, following challenges should be addressed and optimized, such as a) Low conductivity of elemental S (10⁻³⁰ S cm⁻¹) and it's discharged product Li₂S (10⁻¹³ S cm⁻¹) at 25° C.; b) Li polysulfide formation (LiPS), polysulfide shuttling through electrolyte to anode and corroding the anode surface; c) Volume expansion of sulfur cathode and low volumetric energy density.

To address these challenges in sulfur cathode, strategies like introduction of the host materials to improve the conductivity and buffer volume expansion, and interlayers to block the polysulfide shuttling have been researched. However, these methods are yet not successful for higher areal capacity of 4-10 mAh cm⁻³. Widely explored carbon based host materials have low tap density, so densification/high sulfur loading of cathode is not possible. It lowers the practical achievable energy density of Li—S battery (580 WhL⁻¹) than Li-ion batteries (670 WhL⁻¹) for Ni rich cathodes with high tap density. So, cathode with high mass density is required.

To improve the energy and power density of batteries, voltage should be increased and interfacial resistance should be decreased. Electrode-electrolyte interface (EEI) is very important for stable and long term electrochemical performance of a cell. EEI of anode is known as solid electrolyte interphase (SEI) and on cathode it is known as cathode electrolyte interphase (CEI). Battery performance degrades due to several reasons such as decomposition of electrolyte, solid electrolyte interphase formation, particle cracking and loss of contact, structural changes, metal dissolution, and oxidation of additives and corrosion of current collector.

Separator coating to address the polysulfide shuttling is one of the promising methods to improve the practically achievable energy density and cyclability. Several materials such as porous carbon, CNT, CNF and doped carbons have been applied as separator modifier.

One such attempt has been made in US20150318532, which discloses a lithium-sulfur rechargeable battery containing a lithium-containing anode, a sulfur-containing cathode, and a bifunctional separator having a microporous, conductive layer facing the cathode of the battery wherein bifunctional separator inhibits polysulfide diffusion and improves sulfur cathode material reutilization to improve cell cycling stability and discharge capacity. However, microporous carbon used in US20150318532 does not show catalytic properties towards polysulfide conversion.

In WO2020046442, described is the coated separator, prepared by depositing a layer of first sulfonated elastomer composite onto one primary surface of the separator and/or depositing a layer of second sulfonated elastomer composite onto the opposing primary surface of the separator.

Though, significant efforts are taken to prepare coated separator for various energy devices, there still exists a need for the development of coated separator for Li—S batteries that exhibits an exceptionally high specific energy, high energy density, high conductivity, a high cathode specific capacity, a long and stable cycle life of the electrolytic cell or a battery, and which can also avoid shuttling of the electrode compartment, to be commercially used to meet the increasing energy demand in the various sectors of the industry.

### OBJECTS OF THE INVENTION

Therefore in view of the above, it is an important object of the invention to provide coating composition to be coated on a separator to overcome the aforesaid drawbacks.

Another object of the invention is to provide coated separator that demonstrates high specific energy or high energy density.

Yet another object of the invention is to provide the coated separator which prevents the polysulfide shuttling to anodic side.

Yet another objective of the present invention is to provide batteries having ZnP2 based separator to improve the absorption and conversion kinetic of polysulfides for batteries to prevent the shuttling of ions between the electrodes.

Yet another objective of the present invention is to be provide coating composition to be coated on a separator or cathode

### SUMMARY OF THE INVENTION

Accordingly, to meet the aforementioned objects, it is an aspect of the present invention to provide modified separator which can be used to prevent the soluble ion shuttling in batteries.

In an aspect, the present invention provides ZnP2 separator to prevent the shuttling of ions in batteries.

In another aspect, the present invention provides ZnP2 separator to prevent the shuttling of polysulfide ions in Li S batteries.

In one aspect, the present invention relates to a coating composition for an electrochemical cell, the composition comprising: a ZnP₂ slurry, a carbon source and a binder; wherein a ratio of ZnP₂ slurry:a carbon source:binder polymer is in range of 70:20:10 to 80:10:10; wherein said coating composition is an interlayer between an electrode and a separator.

The electrode is selected from anode and cathode.

In second aspect, the present invention relates to a battery comprising:
a) an anode;
b) a cathode;
c) the interlayer as claimed in claim 1, between cathode or anode and separator;
d) a negative case;
e) a positive case;
f) a spring; and
g) a spacer.

The separator is selected from polyethylene film, polypropylene/polyethyelene film or polypropylene/polyethyelene/polypropylene film.

The carbon source is selected from carbon nanotube, super P carbon, acetylene black, Ketjen black, C-65 carbon, mesoporous carbon, microporous carbon, and carbon nanofibers.

The electrochemical cell is selected from a rechargeable alkali metal battery, and metal sulfur battery.

The electrochemical cell is lithium sulfur battery.

In another embodiment, the separator is placed between anode and cathode of the battery, and the coating is facing the cathode side.

In another aspect, the present invention relates to a method for preparation of ZnP₂ slurry as claimed in claim 1 comprising the steps of:
a) taking Zn and P in a molar ratio of 1:2 to 1:5, and
b) phosphorizing the mixture of step a) in a vacuum sealed tube at temperature ranging from 500° C. to 800° C. for period of 10-14 hours to obtain the ZnP₂ slurry.

In another aspect, the present invention relates to a process of preparation of the composition as claimed in claim 1, comprising: physically mixing the ZnP2 slurry with conducting carbon and binder in N-Methyl-2-pyrrolidone in a ratio of 70:20:10 at temperature of 25-30° C. to obtain the coating composition.

The ZnP₂ has a surface area in the range of 20 m²/g to 40 m²/g and a contact angle in the range of 0°-10°.

In yet another aspect, the present invention provides a separator comprising an interlayer of coating composition as disclosed herein.

The composition or battery or separator having said interlayer has a thickness in the range of 5-10 μm.

Due to catalytic properties of ZnP₂ conversion kinetics of polysulfide can be enhanced. The said coated separator have surface anchoring group to bind and catalyze sulfide conversion. Zinc has tendency to react with S and phosphorus will bind with Li to form Li₃P. The researchers of the present invention have also observed that battery with coated separator as described in the present invention showed improved capacity.

Present invention helps to improve the polysulfide conversion kinetics and prevent the polysulfide shuttling. Yet another object of the present invention is to provide coated separator as a barrier to restrict the shuttling which shows improved capacity.

In another aspect, present invention provides a rechargeable alkali metal battery such as Li—S batteries that possesses high specific energy and/or high energy density.

### BRIEF DESCRIPTION OF THE DRAWINGS

FIG. 1 provides XRD data graph of as synthesized ZnP₂.

FIG. 2 shows (a) Diagram of battery, (b) Bare Separator, (c) ZnP₂ coated separator, and (d-e) Fabricated ZnP₂ coated coin cells.

FIG. 3 shows (a) and (b) FESEM, and (c) and (d) HRTEM images of ZnP₂. In FESEM images sheet type morphology can be observed and same is observed in TEM images.

FIG. 4 shows High resolution XPS spectra of ZnP₂, (a) survey spectrum, (b) Zn 2p, and (c) P 2p.

FIG. 5: illustrates (a) BET adsorption-desorption isotherm, and (b) BJH pore size distribution of ZnP₂.

FIG. 6 shows the electrolyte contact angle of (a) the commercial separator, (b) the ZnP₂ coated separator, permeation experiment using (c) pristine separator and (d) ZnP₂ coated separator.

FIG. 7 shows (a) EIS, (b) CV at 0.1 mV/s of pristine and ZnP2 coated separator and (c) 1^{st} to 6^{th} cycle CV scans at 0.1 mV/s and (d) CV scans at different scan rates of ZnP2 coated separator.

FIG. 8 shows (a) GCD at 0.1C, (b) rate performance, (c) stability at 0.1C, and (d) shuttle current measurement at 2.33V of pristine and ZnP₂ coated separator.

FIG. 9 shows (a) rate performance with different volume of electrolyte, (b) stability at 0.5C and 1C of ZnP₂ coated separator with E/S=25 μl/mg.

### ABBREVIATIONS

ZnP₂: Zinc phosphide
FESEM: Field Emission Scanning Electron Microscopy
TEM: Transmission Electron Microscopy
HRTEM: High Resolution Transmission Electron Microscopy
CNT: Carbon Nanotube
PVDF: Polyvinylidene Difluoride
LiTFSI: Lithium bis(trifluoromethanesulfonyl)imide

### DETAILED DESCRIPTION OF THE INVENTION

In order to provide a clear and consistent understanding of the terms used in the present specification, a number of definitions are provided below. Moreover, unless defined otherwise, all technical and scientific terms as used herein have the same meaning as understood by the person skilled in the art.

The use of the word “a” or “an” when used in conjunction with the term “comprising” in the claims and/or the specification may not only mean “one”, but also encompasses the meaning of “one or more”, “at least one”, and “one or more than one”. Similarly, the word “another” may mean at least a second or more.

As used in specification and claim(s), words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The terms “battery” or “electrochemical device” used herein have the same meaning and hence used interchangeably throughout the specification.

The terms “modified separator” or “interlayer between electrode and separator” or “coated separator” used herein have the same meaning and hence used interchangeably throughout the specification.

The present invention describes a coating composition applied on a separator and/or on cathode as an effective means to prevent the soluble polysulfide shuttling in Li—S batteries, which overcomes the drawbacks of the currently available Li—S batteries which use various other coated separators.

The coated separator of the present invention has a surface anchoring group to bind and catalyze sulfide conversion and prevent the polysulfide shuttling to anodic side, wherein Zinc has tendency to react with S and phosphorus will bind with Li to form Li₃P.

Accordingly in an embodiment of the present invention, the coated separator is a phosphide modified separator, which is able to effectively control polysulfide shuttling in Li—S battery. Preferably, ZnP₂ modified separator is provided which is able to effectively control polysulfide shuttling in Li—S battery.

In another embodiment, the present invention describes the process of preparation of ZnP₂ modified separator.

In accordance with the above embodiment, ZnP₂ can be synthesized using vacuum sealed tube method and characterized by different techniques, wherein the process involves use of Zn metal and red phosphorus.

The process for the synthesis of ZnP₂ comprises of the following steps:
a) Zinc (Zn) and red phosphorous (P) are dried thoroughly for 10-12 hours by taking Zn and red P in the predefined ratio of 1:2 to 1:5, and the mixture is grinded in a mortar for 0.5 to 2 hours; and
b) carrying out phosphorization in a vacuum sealed tube at temperature in the range of 500° C. to 800° C. for a time period of 10-14 hours to obtain ZnP₂.

In another embodiment, the present invention provides a process of preparing the cathode electrode; wherein the cathode electrode is prepared by using slurry consisting of sulphur, CNT, and PVDF using an organic solvent, such as NMP. The slurry thus obtained is uniformly coated on a carbon-coated Aluminum foil and then dried in a vacuum drying oven at 55° C.

In accordance with the above embodiment, the separator coating was prepared using slurry of synthesized ZnP₂:Conducting Carbon:Binder with ratio is in range of 70:20:10 to 80:10:10 and coated on separator maintaining the thickness of the coating to be 5-10 μm, which is dried further at 70° C. in an oven and subsequently hot-roll pressed at temperature in the range of 50-60° C.

In another embodiment, the conducting carbon used to make slurry is selected from Super P carbon, Acetylene black, Carbon nanotube, Ketjen black, and C-65 carbon.

In another embodiment, the binder used in slurry is selected from poly acrylic acid, polyvinylidene di-fluoride, carboxy methyl cellulose, and styrene-butadiene rubber.

In another embodiment, the separator is selected from PE film, PP/PE film or PP/PE/PP film.

In another embodiment, the lithium metal was used as a counter electrode.

In yet another embodiment, the electrolytic solution was prepared using 1 M amount of LiTFSI in a mixture of 1:1 volume % of dioxalane and dimethoxy ethane (DME) and 0.3M LiNO₃.

In yet another embodiment, the separator is between Lithium anode and S/CNT cathode and the coating is facing the S/CNT cathode side.

Negative and positive cases of the coin cell battery serve as negative and positive terminal of the battery and are made up of stainless steel. The negative case is equipped with sealant which ensures insulation from positive case. Spring and spacer ensures proper packing of the coin cell.

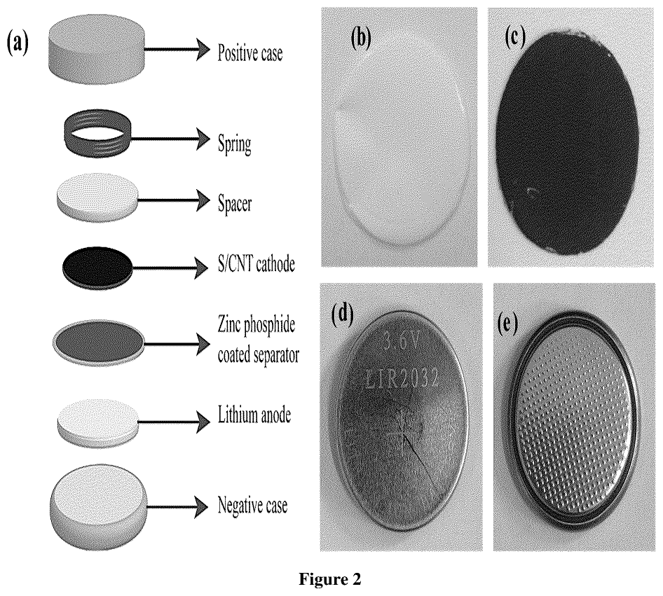

The FIG. 2a shows the schematic of the coin cell assembly. Negative case made up of stainless-steel acts as negative terminal. The Lithium anode is placed upon the negative case and ZnP2 coated separator is kept above the anode with coating side facing the cathode. The separator is wetted with the electrolyte. Above the coated side of separator S/CNT cathode is placed. Spacer and spring are then placed above to ensure tight packing of coin cell. Then positive case is placed above and the coin cell system is cold pressed using hydraulic press to give packed coin cells as in FIG. 2(d) facing positive terminal and 2(e) facing negative terminal.

The FIGS. 2(b) and 2(c) shows blank Celgard separator and ZnP2 coated Celgard separator respectively.

During the studies, present inventors have observed that Phosphides have great electrochemical properties, conductivity, and catalytic properties. Moreover, phosphides possess better absorption properties and less diffusion barrier.

In another embodiment, due to catalytic properties of ZnP₂, the conversion kinetics of polysulfide can be enhanced. The said coated separator have surface anchoring group to bind and catalyze sulfide conversion. Zinc has tendency to react with S and phosphorus will bind with Li to form Li₃P.

In yet another embodiment, the present invention provides a coating layer having a thickness ranging from 5 μm to 10 μm onto a separator and/or cathode or both.

In yet another embodiment, the separator is selected from selected from polyethylene (PE) film, polypropylene (PP)/polyethyelene (PE) film or PP/PE/PP film.

In yet another embodiment, the ZnP2 formed by the vacuum sealed tube method indicates monoclinic ZnP2 phase formation and d-spacing value corresponding to highest intensity peak at 28.2° (102) is 0.32 nm.

In yet another embodiment, the surface area of the ZnP2 is 20 m²/g to 40 m²/g and the contact angle of 0⁰-10⁰. Wherein the contact angle in the context of present invention is defined as angle made between the electrolyte to separator interface.

In preferred embodiment, the surface area of the ZnP₂ is 39.04 m²/g, and the contact angle of the ZnP₂ is 8.2°.

In another embodiment, the present invention provides a lithium-sulfur battery comprising lithium as an anode, electroactive sulfur as a cathode; and a ZnP₂ coated separator.

In another embodiment, the present invention provides a lithium-sulfur battery comprising lithium as an anode, ZnP₂ coated separator/cathode and Sulfur/CNT cathode.

The ZnP2 coating is done as an interlayer between cathode and separator or anode and separator, which catalyzes the polysulfides and hence the coating can be done on anode as well as cathode.

The spring and spacer in the battery is used for compact packing of all components.

### EXAMPLES

Following examples are given by way of illustration. It may be understood for the person skilled in the art that these examples are only typical embodiments of the invention and are not therefore to be considered to be limiting the scope of the present invention.

### Example 1: General Synthetic Method of Preparation of Zinc Phosphorous Slurry (ZnP₂)

a) Taking Zn and P in a predefined ratio ranging from 1:2 to 1:5, and
b) subsequent phosphorization in a vacuum sealed tube at 500° C. to 800° C. for period of 10-14 hours.

The synthesized product is designated as ZnP₂. The ZnP₂ formed by the vacuum sealed tube method indicates monoclinic ZnP2 phase formation and d-spacing value corresponding to highest intensity peak at 28.2° (102) is 0.32 nm.

### Example 2: Preparation of ZnP2 Based Coating Composition

Physically mixing the synthesized ZnP₂ with conducting carbon like carbon nanotube and binder like PVDF in NMP solvent to make smooth slurry in a ratio of 70:20:10 obtain coating composition.

### Example 3: Synthesis of Coated Separator

The separator coating was prepared using slurry of synthesized ZnP₂:Conducting Carbon:Binder in range of 70:20:10 to 80:10:10 ratio and coated on separator maintaining the thickness of the coating to be 5-10 μm coating using PET film, which is dried further at 70⁰ C in an oven and hot-roll pressed further at 50-60⁰ C. The separator having a coating layer of ZnP₂ based composition has a thickness of 5-10 μm.

### Example 4: Preparation of Cathode Electrode

The following experimental process describes the preparation of cathode material comprising the steps of:
a) preparing the slurry consisting of 70 wt % Sulphur, 20 wt % Conducting carbon, and 10 wt % PVDF using NMP as solvent, and
b) the above slurry is used for uniformly coating on a carbon-coated Al foil and then drying in a vacuum drying oven at 55⁰ C. ZnP₂ coating can be also used as a cathode coating. ZnP₂ coating can work as an interlayer between cathode and separator.

### Example 5: Material Characterization

The synthesized product was characterized by various techniques such as powder X-ray diffraction measurements a Philips X'Pert PRO diffractometer with nickel-filtered Cu Kα radiation, field emission scanning electron microscopy (FE-SEM) with Hitachi S-4200 apparatus and transmission electron microscopy, X-ray photoelectron spectroscopy equipped with monochromatic Al Kα (l=1486.6 eV) X-ray radiation and a hemispherical analyzer. The gas adsorption experiment (up to 1 bar) was performed on Quantochrome Autosorb automated gas sorption analyzer.

### 5.1 Electrochemical Characterization

A coin-type test cell (CR2032) was utilized to evaluate the electrochemical performance of cells fabricated using ZnP₂ coated separator. The cathode electrode was prepared by using a slurry consisting of 80 wt % Sulphur, 10 wt % CNT or conducting carbon (CC), and 10 wt % PVDF using NMP as solvent. The obtained slurry was uniformly coated on a carbon-coated Al foil and then dried in a vacuum drying oven. The separator coating was prepared using slurry of synthesized ZnP₂:CNT:PVDF in 70:20:10 or 80:10:10 ratio on celgard 2325 separator. Lithium metal was used as a counter electrode. 1 M amount of LiTFSI in a mixture (1:1, vol %) of dioxalane (DOL) and dimethoxy ethane (DME) and 0.3M LiNO₃ was used as the electrolyte. The cells were assembled in an argon-filled glovebox. The cyclic voltammetry was performed on a Biologic workstation at the scan rate of 0.1 mV/s in the 1.7-2.8 V voltage range. Galvanostatic charge-discharge measurements were performed using an MTI Corp. multichannel battery test system within the voltage range of 1.7-2.8 V.

### Results and Discussion

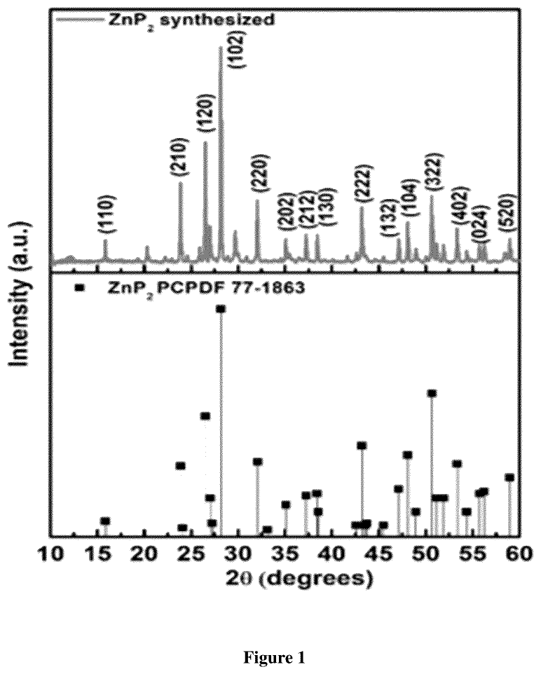

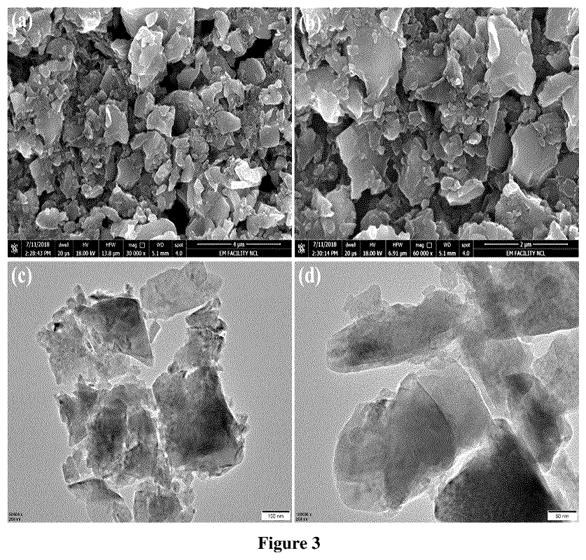

ZnP₂ was synthesized using vacuum sealed tube method and characterized by different techniques. XRD data is presented in FIG. 1 which indicates monoclinic ZnP2 phase formation and d-spacing value corresponding to highest intensity peak at 28.2° (102) is 0.32 nm. To analyze the morphology of the ZnP₂, FESEM and TEM measurements were performed. In FESEM images sheet type morphology can be observed and same is observed in TEM images (FIG. 3).

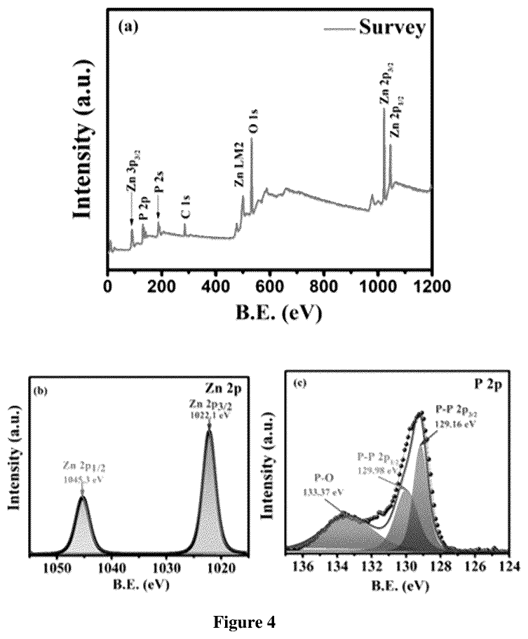

The surface electronic states and chemical composition of ZnP₂ were investigated by X-ray photoelectron spectroscopy (XPS). The XPS survey given in FIG. 4(a) shows the presence of Zn and P in ZnP₂ which is in accordance with the XRD result. FIG. 4(b) shows the Zn 2p spectrum with peaks at 1022.1 eV and 1045.3 eV corresponding to Zn 2p_{3/2} and Zn 2p_{1/2} of Zn—P bond. The P 2p spectrum can be deconvoluted to two spin-orbit doublets, the P—P 2p_{3/2} at 129.16 eV and P—P 2p_{1/2} at 129.98 eV and the third peak can be ascribed to the P—O oxidized species of phosphide as shown in FIG. 4(c).

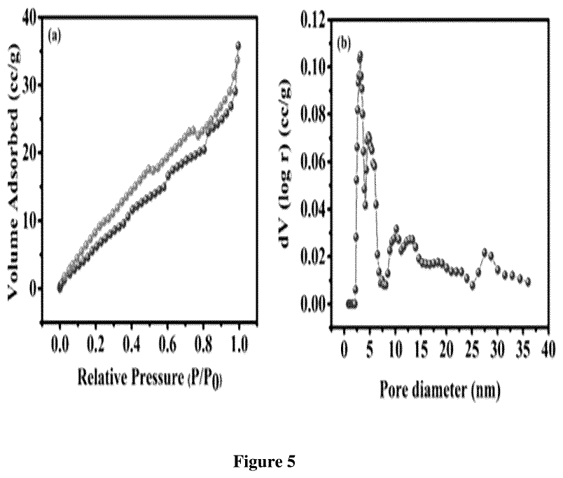

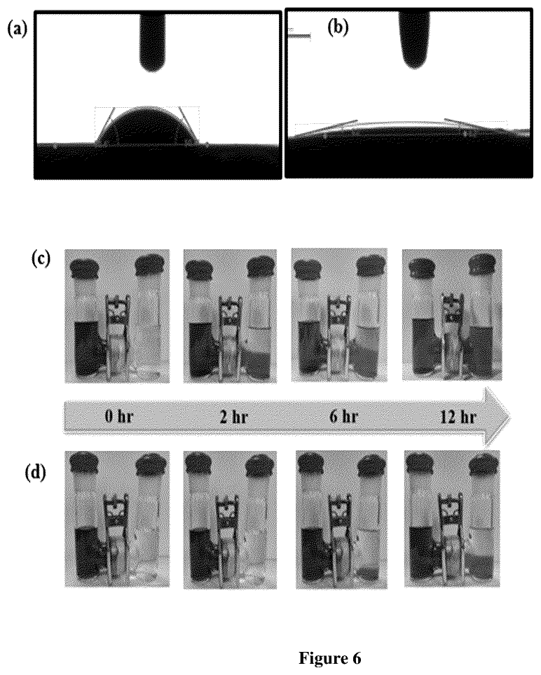

The nitrogen adsorption desorption isotherm indicates the sheet like morphology of ZnP₂ where nitrogen is adsorbed in step like arrangement and the hysteresis in the curve shows slight mesoporosity of the sample as shown in FIG. 5(a). Barett-Joyner-Halenda (BJH) analysis indicates the specific pore size distribution of ZnP₂ is in microporous region and the surface area of the ZnP₂ is 39.038 m²/g. The contact angle measurement was performed to measure the angle made by the intersection of the electrolyte and the separator interface to study the wettability of ZnP₂ coated separator. The commercial separator showed 50.4⁰ contact angle (FIG. 6a) while that of ZnP₂ coated separator was just 8.2⁰ (FIG. 6b) which shows good infiltration rate of electrolyte. The polysulfide permeation experiment is conducted in a H-cell where one side is filled with 40 ml of 8 mM Li₂S₆ solution and the other side with DME solvent and the pristine and coated separator is attached in between both sides. Permeation of polysulfide is fast in pristine separator (FIG. 6c) and slow permeation of polysulfides can be seen in ZnP₂ coated separator (FIG. 6d) which denotes the inhibiting effect polysulfide shuttling of coated separator.

### Example 6: Results of the Electrochemical Characterization

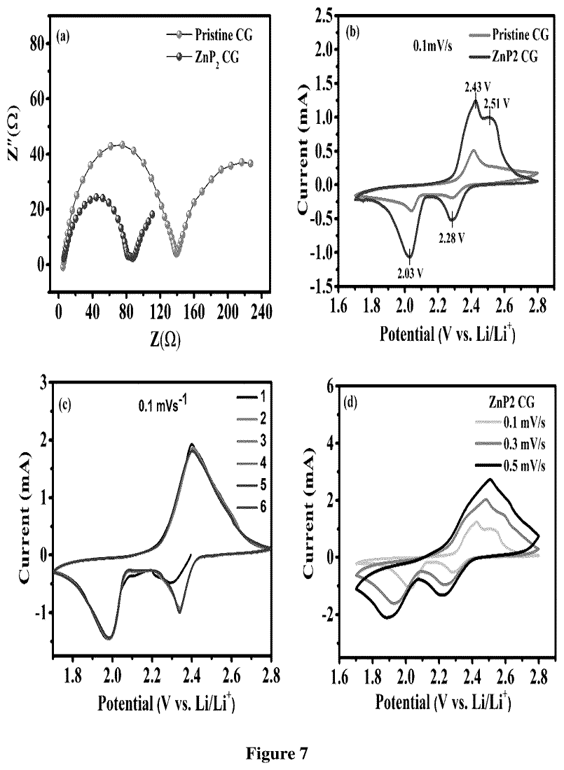

For initial electrochemical testing, impedance and CV measurements were executed and data is shown in FIG. 6. From the EIS, insights about charge transfer kinetics and conductivity of the materials can be obtained. The charge transfer resistance (R_{ct}) is decreased in ZnP₂ coated separator to 87Ω from 139Ω in pristine separator which signifies better conversion kinetics (FIG. 7a). To understand the redox behaviour of S-cathode, CV experiments were performed. In the cathodic scan of CV, peak at 2.28 V represents reduction of sulfur into long chain polysulfides (Li₂Sₙ: 4≤n≤8) and peak at 2.03 represents conversion to lower order polysulfides (Li₂Sₙ: n<4). In the anodic scan of CV, two peaks in between 2.3-2.6 V indicates back conversion to high order polysulfide and elemental sulfur (FIG. 7b). More peak current in the cell with modified separator signifies enhanced conversion kinetics and redox behaviour than pristine separator. In FIG. 7(c) the redox peaks at 0.1 mV/s is noted for 1-6 cycles in ZnP₂ coated separator. The cycles from 2-6 overlap well and no obvious peak shifts are to be seen either in the intensity or the potential indicating high electrochemical stability and good enhancement in the kinetics of polysulfide conversion using ZnP₂, which is also clear from different scan rate CV scans of ZnP₂ coated separator (FIG. 7d).

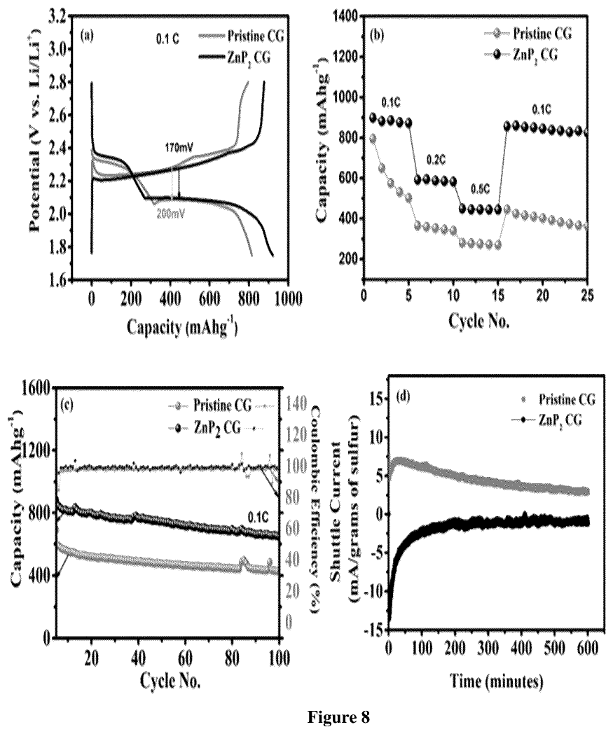

GCD curves of pristine and ZnP₂ coated separator at 0.1C are shown in FIG. 8. The first discharge capacity is 814 mAhg⁻¹ and 922 mAhg⁻¹ and first charge capacity is 793 mAhg⁻¹ and 876.58 mAhg⁻¹ in pristine and ZnP₂ coated separator, respectively. The polarization potential is associated with redox reaction kinetics of polysulfides conversion in liquid electrolyte. From the GCD curves, we obtained polarization potential value which is decreased to 170 mV in ZnP₂ coated separator from 200 mV in pristine separator. Reduced value of polarization potential indicates accelerated polysulfide conversion kinetics and better reversibility of charge-discharge reaction in cell with modified separator. To investigate properties of modified separator coating in more details, rate performance and stability experiments were performed. Rate performance data of pristine and ZnP₂ coated separator is shown in FIG. 8b. The capacity obtained at 0.1C is 795 mAhg⁻¹ and 897 mAhg⁻¹ for pristine separator and ZnP₂ coated separator, respectively. The capacity obtained at 0.2C is 358 mAhg⁻¹ and 595 mAhg⁻¹ for pristine separator and ZnP₂ coated separator, respectively. The capacity obtained at 0.5C is 279 mAhg⁻¹ and 448 mAhg⁻¹ for pristine separator and ZnP₂ coated separator, respectively. When the scan rate is reversed to 0.1C, the capacity value is 444 mAhg⁻¹ and 865 mAhg⁻¹ for pristine separator and ZnP₂ coated separator, respectively. (FIG. 8b).

The comparison of stability study at 0.1C is shown in FIG. 8 (c). The first charge capacity is 738 mAhg⁻¹ and 814 mAhg⁻¹ for pristine and ZnP₂ coated separator, respectively. Also, after 100 cycles the charge capacity is 425 mAhg⁻¹ and 608 mAhg⁻¹ respectively. The coulombic efficiency of ZnP₂ coated separator was 99.3% while that of Pristine separator was 96.8% which suggests that ZnP₂ coated separator has enhanced the kinetics of polysulfide conversion at sulfur cathode. Stability of ZnP₂ coated separator is better and it also proves the catalytic property of ZnP₂. To further study the polysulfide conversion kinetics the shuttle current is measured for ZnP₂ coated separator and pristine separator at 2.33V as in FIG. 8 (d). In this study the cathode potential is maintained constant at 2.33V by passage of electric current which will reoxidise the polysulfides reaching the cathode and a corresponding reduction reaction will occur at the anode. Thus, by holding the cathode potential constant, we can measure the steady state current which is the rate of shuttling process. In ZnP₂ coated separator the shuttle current measured came to a steady state value near to zero indicating inhibition of shuttle effect, meanwhile in pristine separator the steady state shuttle current is higher and it gets reduced with time indicating retention of insoluble products of soluble polysulfide conversion which is the reason for capacity fading and lower coulombic efficiency of pristine separator.

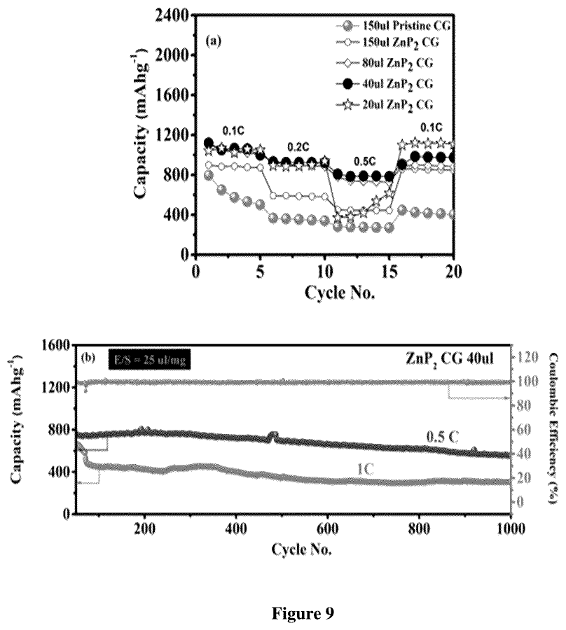

Electrolyte constitute the largest weight fraction of a lithium sulfur battery; hence it represents the most important lever in altering the specific energy of the cell. Thus, we study the electrolyte to sulfur (E/S) ratio of the cell which is the electrolyte volume used in the cell with respect to the amount of sulfur in the cathode. FIG. 9 (a) depicts the rate performance study with different volume of electrolyte to optimize the E/S ratio of the ZnP₂ coated separator LSB. The 20 μl and 40 μl volume electrolyte shows better rate performance, though 20 μl fails to show good capacity at higher C rates while 40 μl still shows higher capacity at 0.5C rate. Considering the good electrochemical chemical performance of 40 μl volume of modified separators, we carried out stability study at 0.5C and 1C result is shown in FIG. 9 (b). The ZnP₂ coated separator exhibited first capacity charge of 649 mAhg⁻¹ and 423 mAhg⁻¹ at 0.5C and 1C, respectively. After 1000 cycles the capacity of ZnP₂ modified separator with E/S ratio of 25 μl/mg is 436 mAhg⁻¹ and 302 mAhg⁻¹ at 0.5C and 1C respectively with 99.3% coulombic efficiency.

### Advantages of the Invention

ZnP₂ modified separator is able to effectively control polysulfide shuttling in Li—S battery.
Due to catalytic properties of ZnP₂ conversion kinetics of polysulfide are enhanced.
Polarization for redox conversion of polysulfide is reduced which indicates accelerated polysulfide conversion kinetics and better reversibility of charge-discharge reaction in cell with modified separator.
ZnP₂ modified separator is better than non-polar carbon coatings on separator.
Phosphides possess better absorption properties and less diffusion barrier.
ZnP₂ functions as catalyst as well as coating material and allows good working of the battery.

1. A coating composition for an electrochemical cell, the coating composition comprising:
zinc phosphide (ZnP₂);
a carbon source; and
a binder, wherein the ZnP₂, the carbon source, and the binder are in a weight ratio in a range of 70:20:10 to 80:10:10.

2. The coating composition as claimed in claim 1, wherein the carbon source is selected from the group consisting of carbon nanotubes (CNT), super P carbon, acetylene black, Ketjen black, C-65 carbon, mesoporous carbon, microporous carbon, and carbon nanofibers.

3. The coating composition as claimed in claim 1, wherein the binder is selected from the group consisting of poly acrylic acid, polyvinylidene di-fluoride, carboxy methyl cellulose, and styrene-butadiene rubber.

4. The coating composition as claimed in claim 1, wherein the ZnP₂ has a surface area in a range of 20 m²/g to 40 m²/g and a contact angle in a range of 0° to 10°.

5. The coating composition as claimed in claim 1, wherein the coating composition is configured to be applied as a coating on a separator, wherein the separator is in between electrodes.

6. The coating composition as claimed in claim 5, wherein the electrode is an anode or a cathode, and wherein the anode comprises lithium anode and the cathode comprises sulphur/CNT (S/CNT) and wherein the coating is facing the (S/CNT) cathode.

7. The coating composition as claimed in claim 5, wherein the coating has a thickness in a range of 5-10 μm on the separator.

8. A method for coating a separator of an electrochemical cell with a coating composition as claimed in claim 1, the method comprising:
providing Zn and P in a molar ratio ranging from 1:2 to 1:5;
subsequently phosphorizing in a vacuum sealed tube at 500° C. to 800° C. for a period of 10-14 hours to obtain ZnP₂;
mixing the ZnP₂, conducting carbon and a binder in a ratio of 70:20:10 in a solvent at a temperature in a range of 25-30° C. to obtain a slurry; and
coating the separator with the slurry to obtain a coated separator.

9. The method as claimed in claim 8, further comprising:
drying the coated separator at 70⁰ C in an oven; and
hot-roll pressing at 50-60⁰ C to obtain the final coated separator.

10. The method as claimed in claim 8, wherein the coating has a thickness in a range of 5-10 μm.

11. The method as claimed in claim 8, wherein the solvent is N-Methyl-2-pyrrolidone.

12. The method as claimed in claim 8, wherein the ZnP₂ is monoclinic and has a d-spacing value of 0.32 nm corresponding to an intensity peak at 28.2°.

13. The method as claimed in claim 8, wherein the ZnP₂ has a surface area in a range of 20 m²/g to 40 m²/g and a contact angle in a range of 0° to 10°.

14. The method as claimed in claim 8, wherein the separator is selected from the group consisting of polyethylene film, polypropylene-polyethylene film, and polypropylene-polyethylene/polypropylene film.

15. A battery comprising the coated separator as claimed in claim 8 for an electrochemical cell, the battery comprising:
an anode;
a cathode;
a negative case configured to serve as a negative terminal;
a positive case configured to serve as a positive terminal, wherein the negative case and the positive case are made of stainless steel, and wherein the negative case is provided with a sealant to ensure insulation from the positive case;
a spring positioned below the positive case; and
a spacer provided above the cathode; wherein the spring and the spacer provide packing,
wherein the coated separator is positioned between the cathode and the anode, and wherein the separator is coated with a slurry comprising ZnP₂, a carbon source, and a binder, and wherein the ZnP₂, the carbon source, and the binder are in a weight ratio in a range of 70:20:10 to 80:10:10.

16. The battery as claimed in claim 15, wherein the coated separator is selected from the group consisting of polyethylene film, polypropylene-polyethylene film, and polypropylene-polyethylene-polypropylene film.

17. The battery as claimed in claim 15, wherein the battery is configured to be used in an electrochemical cell.

18. The battery as claimed in claim 17, wherein the electrochemical cell is a rechargeable alkali metal battery, a metal sulfur battery, or a lithium sulfur (Li—S) battery.

19. The battery as claimed in claim 18, wherein the coated separator controls polysulfide shuttling in Li—S battery.

20. The battery as claimed in claim 18, wherein the battery has a capacity of 998 mAhg⁻¹ at 0.1C, 674 mAhg⁻¹ at 0.2C and 435 mAhg⁻¹ at 0.5C.
